(19) United States
(12) Patent Application Publication
(10) Pub. No.: US 2012/0140455 A1
(43) Pub. Date: Jun. 7, 2012

(54) ILLUMINATING APPARATUS

(75) Inventor: KUO-CHENG CHANG, Chu-Nan (TW)

(73) Assignee: FOXSEMICON INTEGRATED TECHNOLOGY, INC., Chu-Nan (TW)

(21) Appl. No.: 13/292,099

(22) Filed: Nov. 9, 2011

(30) Foreign Application Priority Data
Dec. 6, 2010 (TW) 099142259

(51) Int. Cl. F21L 4/02; F21L 4/08; F21L 4/00

(52) U.S. Cl. 362/183; 362/191; 362/184

(57) ABSTRACT

An illuminating apparatus includes a main body for fixing the illuminating apparatus to a support, a connecting member rotatably and detachably mounted on the main body for electrically connecting with an external power source, and a light illuminating module securely mounted on the connecting member. The light illuminating module includes a light source and a power storage device supplying power to the light source. The light source and the power storage device both electrically connect with the connecting member.

### BACKGROUND

1. Technical Field

The present disclosure generally relates to illuminating apparatus, and particularly to an illuminating apparatus having an improved versatility.

2. Description of Related Art

Nowadays, illuminating apparatus become more and more indispensable in people's everyday life. Different illuminating apparatus are used in different occasions, such as street lamps on the streets for illuminating the roads/streets, reading lamps in houses for providing required lighting when one reads, and portable flashlights for use in emergency such as blackout. However, these illuminating apparatus usually have special applications in special occasions and can not be used in other occasions. Since some of the illuminating apparatus, for example, the portable flashlights, are used seldom before they are discarded due to a breakdown of component(s) thereof due to aging/oxidation, waste is thus resulted. Furthermore, it is difficult to readily get the portable flashlight during a blackout since people always forget where it is located when the blackout occurs.

What is needed, therefore, is an illuminating apparatus which can overcome the limitations described.

### BRIEF DESCRIPTION OF THE DRAWINGS

FIG. 1 is an isometric, assembled view of an illuminating apparatus in accordance with an embodiment of the present disclosure.

FIG. 2 is an exploded view of the illuminating apparatus of FIG. 1.

FIG. 3 is an exploded view of a light illuminating module and a connecting member of the illuminating apparatus of FIG. 1.

### DETAILED DESCRIPTION

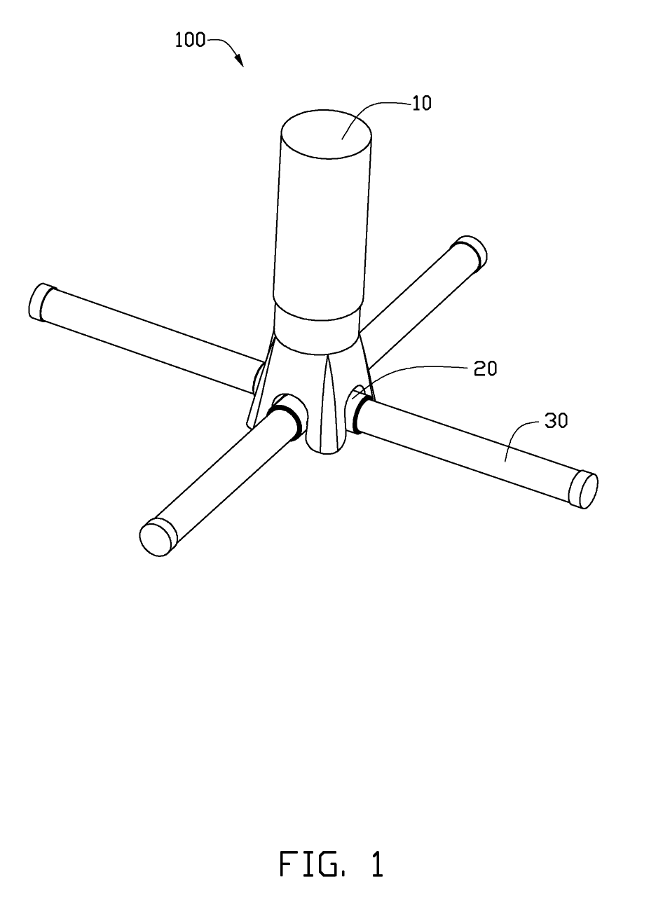

Referring to FIG. 1, an illuminating apparatus 100 in accordance with an embodiment of the present disclosure is shown. The illuminating apparatus 100 includes a main body 10, a plurality of connecting members 20 and a plurality of light illuminating modules 30. Each connecting member 20 connects one light illuminating module 30 to the main body 10. In this embodiment, there are four light illuminating modules 30 and four connecting members 20 respectively connecting the four light illuminating modules 30 to the main body 10.

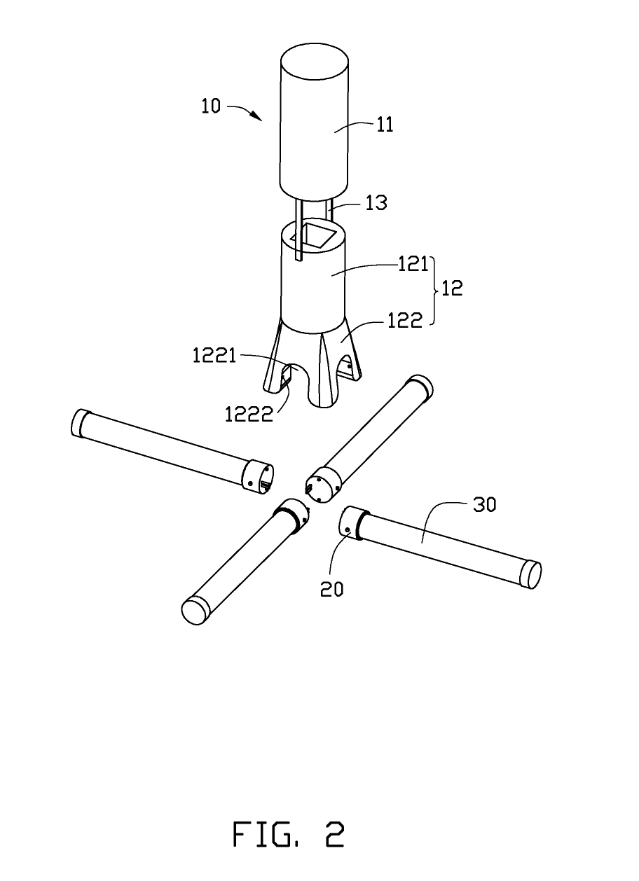

Referring to FIG. 2, the main body 10 includes a mounting portion 11, a stretching portion 12 and two connecting poles 13 connecting between the stretching portion 12 and the mounting portion 11.

The mounting portion 11 is used to mount the illuminating apparatus 100 to a predetermined object, such as a ceiling or a desk. The mounting portion 11 is a hollow cylinder. The stretching portion 12 is movably mounted with the mounting portion 11. The stretching portion 12 includes a cylindrical neck 121 and an expanded mounting seat 122.

The mounting seat 122 extends and expands outwardly from a bottom end of the neck 121. The mounting seat 122 defines four recesses 1221 in a bottom end thereof. The four recesses 1221 are evenly spaced from each other and oriented at four mutually perpendicular directions. Each of the recesses 1221 has an archway shape. The mounting seat 122 defines two mounting holes 1222 at opposite sides of each recess 1221. The two mounting holes 1222 are substantially located at the same level.

The two connecting poles 13 are connected between the mounting portion 11 and a top of the neck 121 of the stretching portion 12. One end (bottom end as viewed from FIG. 2) of each of the two connecting poles 13 is immovably mounted with the neck 121 of the stretching portion 12. Another end (top end as viewed from FIG. 2) of each of the two connecting poles 13 is movably mounted with an inner wall of the mounting portion 11. The two connecting poles 13 can be moved back into the mounting portion 11 or drawn out of the mounting portion 11 to adjust an illuminating height of the illuminating apparatus 100 when the illuminating apparatus 100 is particularly used as a desk lamp with the mounting portion 11 seated on a desk.

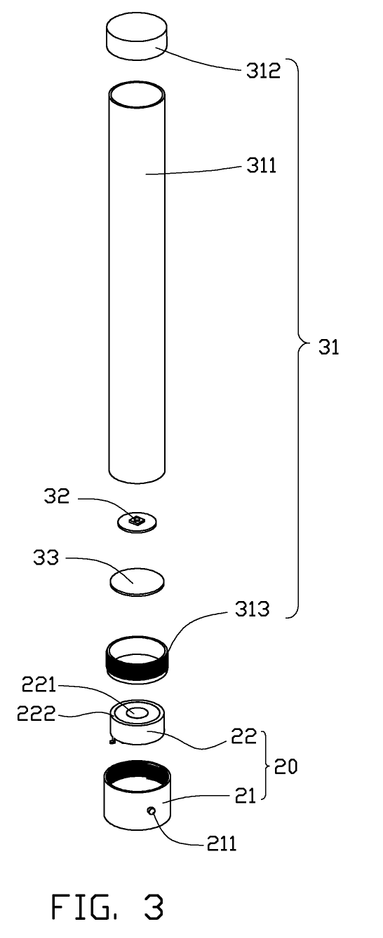

Referring to FIG. 3, the connecting member 20 includes a lamp holder 21 and a converter 22.

The lamp holder 21 is cylindrical and hollow. Two pivots 211 are respectively formed at two opposite sides of a circumferential wall of the lamp holder 21. The lamp holder 21 is received in a corresponding recess 1221 of the mounting seat 12. The two pivots 211 of the lamp holder 21 are rotatably received in the two mounting holes 1222 at two opposite sides of the corresponding recess 1221 respectively. Thus, the light illuminating module 30 connected to the lamp holder 21 is rotatable with respect to the main body 10. An angle formed between the light illuminating module 30 and the main body 10 is adjustable through a rotation of the light illuminating module 30, so as to adjust an illuminating effect of the illuminating apparatus 100. It should be understood that the pivots 211 can be modified be formed on the mounting seat 122, whereas the mounting holes 1222 are defined in the lamp holder 21. Since the connecting member 20 is pivotally connected to the mounting seat 122, a disassembly of the light illuminating module 30 is also facilitated.

The converter 22 is cylindrical and located in the lamp holder 21 and electrically connected with two conductive pins (shown in FIG. 2, not labeled) through wires or conductive tabs (not shown). The conductive pins are used for connecting with an external power source (not shown), and extend outwardly from an outer end face of the lamp holder 21. A first electrode 221 and a second electrode 222 are provided on a top surface of the converter 22. The first electrode 221 and the second electrode 222 are insulative from each other. The light illuminating module 30 is mounted on the top surface of the converter 22, and connects the first electrode 221 and second electrode 222 electrically. In this embodiment, the first electrode 221 is located at a middle portion of the top surface of the converter 22, while the second electrode 222 is annular and surrounds the first electrode 221; thus the light illuminating module 30 can be rotated relative to the converter 22 freely while still maintaining a correct electrical connection between the light illuminating module 30 and the converter 221.

The light illuminating module 30 includes an envelope 31, a light source 32 and a power storage device 33.

The envelope 31 includes a tubular body 311, and a first cap 312 and a second cap 313 sealed at two opposite ends of the tubular body 311. The tubular body 311 is made of transparent glass or plastic. The second cap 313 is threadedly connected to the lamp holder 211. The second cap 313 electrically connects the first and second electrodes 221, 222 of the converter 22 to electrically connect the light illuminating module 30 with the converter 22.

The light source 32 includes an light emitting diode (LED). The light source 32 is mounted in the second cap 313 and electrically connecting to the converter 22 through the second cap 313 and the power storage device 33. The power storage device 33 is a rechargeable battery and positioned in the second cap 313 between the light source 32 and the second cap 313 and electrically connects to the light source 32 and the converter 22 via the second cap 313. The power storage device 33 supplies power to the light source 32 when the connecting member 20 together with the light illuminating module 30 is removed from the mounting seat 122. The power storage device 33 is energized by the external power source though the second cap 313 and the converter 22 when the connecting member 20 together with the illuminating module 30 is mounted to the mounting seat 122.

The illuminating apparatus 100 of the present disclosure can be mounted on a ceiling as a pendant lamp, through connection of the mounting portion 11 of the main body 10 to the ceiling; alternatively, the mounting portion can be placed on a desk, such that the illuminating apparatus 100 acts as a reading lamp. In addition, each light illuminating module 30 of the illuminating apparatus 100 is configured with a power storage device 32; thus each of the light illuminating module 30 can be disassembled from the illuminating apparatus 100 to act as a flashlight during an emergency such as a blackout. Furthermore, the illuminating height and illuminating effect of the illuminating apparatus can be conveniently adjusted through rotations of the light illuminating modules 30, therefore enabling the illuminating apparatus 100 to meet different requirements. In brief, the illuminating apparatus 100 of the present disclosure can be used in different occasions, thus avoiding waste and improving versatility.

It is to be understood, however, that even though numerous characteristics and advantages of the exemplary embodiments have been set forth in the foregoing description, together with details of the structures and functions of the embodiments, the disclosure is illustrative only; and that changes may be made in detail, especially in matters of shape, size, and arrangement of parts within the principles of the embodiments to the full extent indicated by the broad general meaning of the terms in which the appended claims are expressed.

What is claimed is:

1. An illuminating apparatus comprising:
a main body for fixing the illuminating apparatus to a supporting object;
a connecting member rotatably and detachably mounted on the main body for electrically connecting with an external power source;
a light illuminating module secured to the connecting member, the light illuminating module comprising a light source and a power storage device for supplying power to the light source, the light source and the power storage device both electrically connecting with the connecting member.

2. The illuminating apparatus of claim 1, wherein the connecting member is rotatably mounted on the main body through a pivot connection between the connecting member and the main body.

3. The illuminating apparatus of claim 2, wherein the pivot connection comprises two pivots, and the two pivots are respectively formed at two opposite sides of the connecting member.

4. The illuminating apparatus of claim 3, wherein the main body defines two mounting holes therein corresponding to the two pivots, and the two pivots are rotatably received in the two mounting holes respectively.

5. The illuminating apparatus of claim 4, wherein the main body further defines a recess therein, the two mounting holes are respectively defined at opposite sides of the recess, and the connecting member is received in the recess.

6. The illuminating apparatus of claim 2, wherein the connecting member comprises a lamp holder and a converter received in the lamp holder, the lamp holder is cylindrical, the pivot connection comprises two pivots, the two pivots are respectively formed on two opposite sides of a circumferential wall of the lamp holder.

7. The illuminating apparatus of claim 6, wherein the light illuminating module is mounted in the lamp holder of the connecting member by means of threaded connection.

8. The illuminating apparatus of claim 6, wherein the light illuminating module further comprises an envelop, the envelop comprises a body and a cap mounted at an end of the body, the light source and the power storage device are mounted in the cap, and the cap threadedly engages with the lamp holder.

9. The illuminating apparatus of claim 8, wherein the body is tubular and made of transparent glass or plastic.

10. The illuminating apparatus of claim 6, wherein the converter is provided with a first electrode and a second electrode on a surface thereof abutting against the light illuminating module, the first electrode is located at a middle portion of the surface, and the second electrode surrounds the first electrode and insulative from the second electrode.

11. The illuminating apparatus of claim 1, wherein main body comprises a mounting portion and a stretching portion movably connecting with the mounting portion, whereby a distance between the mounting portion and the stretching portion is adjustable.

12. The illuminating apparatus of claim 11, wherein the stretching portion is connected with the mounting portion through two connecting poles, the mounting portion is cylindrical and hollow, one end of each of the two connecting poles is fixedly mounted with the stretching portion, and another end of each of the two connecting poles is movably mounted with an inner wall of the mounting portion.

13. The illuminating apparatus of claim 11, wherein the stretching portion comprises a neck connecting with the mounting portion at one end of the stretching portion and a mounting seat formed at an opposite end of the stretching portion, the mounting seat defines a recess therein, and the light illuminating module is rotatably mounted in the recess.

14. The illuminating apparatus of claim 13, wherein the light illuminating module comprises a plurality of light illuminating modules, the mounting seat defines a plurality of recesses, the plurality of recesses are evenly spaced from each other, each of the plurality of light illuminating modules is rotatably mounted in a corresponding one of the plurality of recesses.

15. The illuminating apparatus of claim 14, wherein the mounting seat defines four recesses evenly spaced from each other and oriented at four mutually perpendicular directions.

16. The illuminating apparatus of claim 1, wherein the light source comprises an light emitting diode.

17. The illuminating apparatus of claim 1, wherein the power storage device is a rechargeable battery.
